(19) United States
(12) Patent Application Publication
(10) Pub. No.: US 2026/0074499 A1
(43) Pub. Date: Mar. 12, 2026

(54) MULTI-CABLE MANAGEMENT APPARATUS

(71) Applicant: JOHN MEZZALINGUA ASSOCIATES, LLC, Liverpool, NY (US)

(72) Inventors: Morgan COOK, Oakdale, PA (US); Thomas URTZ, North Syracuse, NY (US); Brandon STEVENS, Liverpool, NY (US); Christopher NATOLI, Baldwinsville, NY (US)

(21) Appl. No.: 19/107,729

(22) PCT Filed: Sep. 1, 2023
(86) PCT No.: PCT/US2023/031843

§ 371 Date: Feb. 28, 2025

Related U.S. Application Data
(60) Provisional application No. 63/403,480, filed on Sep. 2, 2022.

(51) Int. Cl. H02G 3/32; F16L 3/12

(52) U.S. Cl. CPC H02G 3/32; F16L 3/12

(57) ABSTRACT

A cable management apparatus has a multi-clip frame having a plurality of anchor brackets. Mounted to each anchor bracket is a multi-cable clip that has a plurality of tabs configured to define a plurality of slots, wherein each slot is configured to hold a cable. Each multi-cable clip is mounted to its corresponding anchor bracket by a mounting pin that has a key handle at a first end and a fastener at a second end.

### CROSS REFERENCE TO RELATED APPLICATIONS

This application claims the benefit of priority to U.S. Provisional Patent Application No. 63/403,480, filed Sep. 2, 2022, which is incorporated by reference int its entirety.

### BACKGROUND OF THE DISCLOSURE

### Field of the Disclosure

The present disclosure relates to wireless communications, and more particularly, to cable management systems for antenna cables.

### Related Art

Modern macro cellular antennas typically have many ports whereby each port carries an RF (Radio Frequency) signal for a given frequency band, polarization, and MIMO (Many Input Many Output) layer. The addition of new frequency bands and MIMO capabilities increases the number of ports, and thus the number of cables requires to connect each port to a nearby cellular base station. Given that a macro cellular antenna may be mounted on top of a cellular tower, it has become an increasing challenge to manage the cables such that they are securely fixed to the tower and that they do not move or interfere with each other under wind conditions. This problem is compounded by the deployment of an increasing number of cellular macro antennas per cell tower.

Conventional cable management solutions involve complex systems of rods and clips that are made of different materials, require multiple tools to install, and typically only handle a single cable. This causes complications when installing cables, especially in situations where a technician has to climb a tower to affix the cables, and the conventional solutions are subjected to extreme temperature changes. Further, conventional cable management solutions typically are designed for a single type of deployment (e.g., tower mount, wall mount, etc.), requiring that technicians have a multitude of tools on hand for cellular deployments.

Accordingly, what is needed is a cable management system that is easy to deploy, has few parts, does not require many tools to install, and involves the use of a single material such that the parts have the same thermal expansion coefficients.

### SUMMARY OF THE DISCLOSURE

An aspect of the present disclosure involves a cable management apparatus. The cable management apparatus comprises an anchor bracket; and a multi-cable clip mounted to the anchor bracket, wherein the multi-cable clip has a plurality of tabs defining a plurality of slots, wherein each of the plurality of slots is configured to hold a cable.

Another aspect of the present disclosure involves a cable management apparatus. The cable management apparatus comprises a multi-clip frame having a plurality of anchor brackets; and a plurality of multi-cable clips, wherein each of the multi-cable clips is mounted to a corresponding anchor bracket.

### BRIEF DESCRIPTION OF THE DRAWINGS

FIG. 1 illustrates an exemplary cable management system according to the disclosure.

FIGS. 2A and 2B illustrate an exemplary multi-cable clip according to the disclosure.

FIG. 3 illustrates an exemplary mounting pin of a first embodiment of the disclosure.

FIG. 4 illustrates a subassembly of a multi-cable clip and mounting pin of a first embodiment of the disclosure.

FIG. 5 illustrates two exemplary multi-cable clips installed within a respective anchor bracket according to the disclosure.

FIG. 6 repeats the illustration of FIG. 1 but highlights details of the mounting of multi-cable clips.

FIG. 7 illustrates an exemplary standalone anchor bracket according to the disclosure.

FIGS. 8A and 8B illustrate an exemplary subassembly of a multi-cable clip and a hand-turn mounting pin of a second embodiment of the disclosure.

FIGS. 9A and 9B illustrate the exemplary subassembly of FIGS. 8A and 8B, as installed in a standalone mounting bracket according to the disclosure.

FIGS. 10A and 10B illustrate an exemplary subassembly of a multi-cable clip and a hex key mounting pin of a second embodiment of the disclosure.

FIGS. 11A and 11B illustrate the exemplary subassembly of FIGS. 10A and 10B, as installed in a standalone mounting bracket according to the disclosure.

### DESCRIPTION OF EXEMPLARY EMBODIMENTS

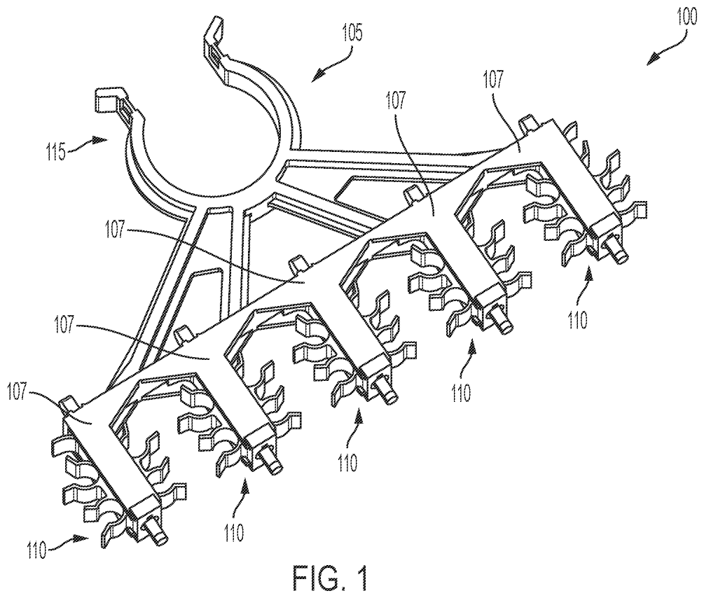

FIG. 1 illustrates an exemplary cable management system 100 according to the disclosure. Cable management system 100 has a multi-clip frame 105 having a plurality of anchor brackets 107. Each anchor bracket 107 holds a multi-cable clip 110, each of which is configured to hold multiple cables (four, in the exemplary embodiment). Multi-clip frame 105 may have a pole-mount bracket 115, which enables multi-clip frame 105 to be mounted to a pole, which may be a pole on which a macro cellular antenna (not shown) is mounted, or part of a cell tower (also not shown). The components of cable management system 100 may be formed of an injection molded plastic, such as nylon or an acetyl polymer. The components may be formed of the same material, or of similar materials with slight differences in hardness.

Variations to multi-clip frame 105 are possible. For example, multi-clip frame 105 may be configured to be wall mounted, in which case pole-mount bracket 115 may be replaced with a wall mount. Further, although exemplary multi-clip frame 105 is illustrated having five anchor brackets 107 with multi-cable clips 110, more or fewer anchor brackets 107 are possible. It will be understood that such variations are possible and within the scope of the disclosure.

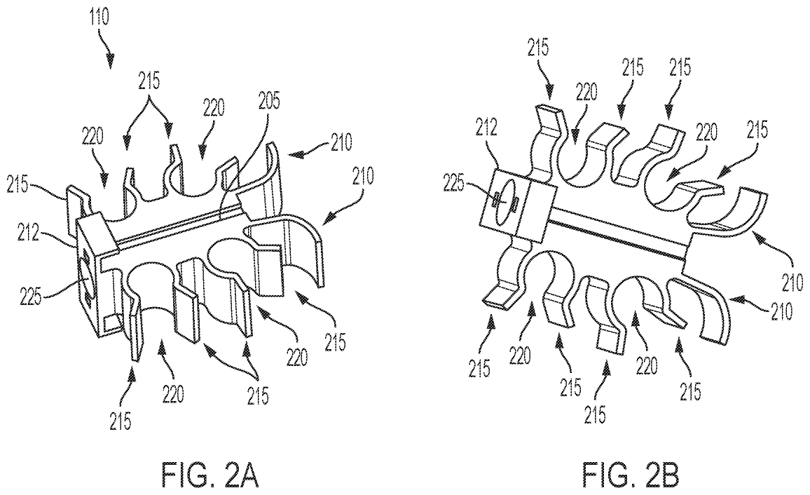

FIGS. 2A and 2B illustrate an exemplary multi-cable clip 110 according to the disclosure. Multi-cable clip 110 has a body having a channel 205 for engaging with anchor bracket 107; a pair of mounting flanges 210 that are used to guide and snap in place the multi-cable clip 110 to anchor bracket 107; a plurality of tabs 215 that define a plurality of slots 220 into which a cable may be inserted; and a mounting base 212, which is used to install multi-cable clip 110 into anchor bracket 107. At mounting base 212 is a cylindrical aperture 225 that runs the length of multi-cable clip 110. Multi-cable clip 110 may be formed of a single piece of material by injection molding or similar processes and may be formed of a single piece of material. The material may be an engineered polymer with a glass fill that provides sufficient stiffness for enabling cables to be inserted into slots 220 and held fast. Example materials include an acetyl homopolymer, or a softer plastic having a glass fill.

The dimensions of multi-cable clip 110 may be driven by the diameter of the cables to be inserted into slots 220. Variations to multi-cable clip 110 are possible. For example, although the illustrated multi-cable clip 110 has four slots 220 (for four cables), more or fewer slots are possible. Further, all of the slots 220 may be disposed on one side of multi-cable clip 110, which may be useful for mounting against a wall. Additionally, although the four exemplary slots 220 are the same diameter, different slots (as defined by tabs 215) may have different diameters. This may be useful in deployments in which different cable diameters may be used. It will be understood that such variations are possible and within the scope of the disclosure.

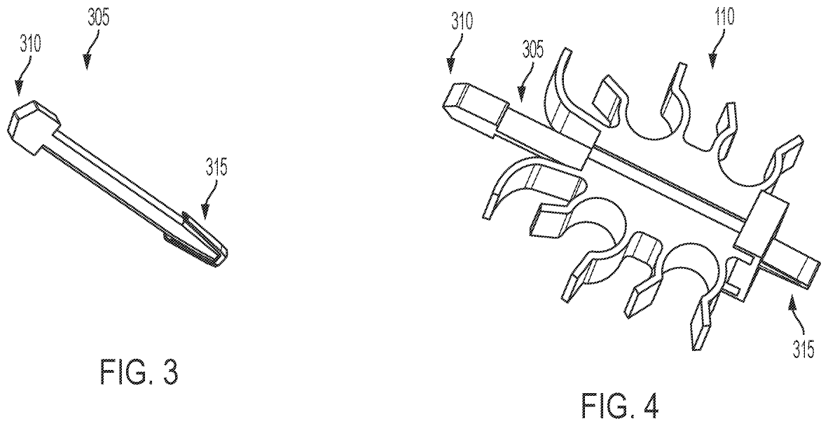

FIG. 3 illustrates an exemplary mounting pin 305 according to a first embodiment of the disclosure. Mounting pin 305 has a key handle 310 at a first end and a retaining feature 315 at a second end. Mounting pin 305 may be formed of the same material as multi-cable clip 110, or a material having the same thermal expansion coefficient for stability in extreme temperatures and temperature changes.

FIG. 4 illustrates a subassembly 400 having a multi-cable clip 110 and mounting pin 305. As illustrated, mounting pin 305 is inserted into cylindrical aperture 225 within multi-cable clip 110 such that mounting pin 305 is able to rotate freely within cylindrical aperture 225 and so that mounting pin 305 may be prevented from removal by the opening of retaining feature 315 once it opens after emerging from cylindrical aperture 225. Subassembly 400 may be integrated as illustrated by the manufacturer or in preparation for being shipped to the location in the field where it will be subsequently integrated into anchor bracket 107.

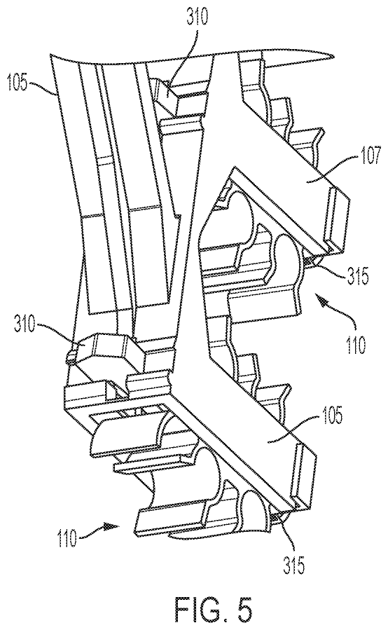

FIG. 5 illustrates two exemplary multi-cable clips 110 installed within a respective anchor bracket 107 of multi-clip frame 105 according to the disclosure. Two subassemblies of multi-cable clip 110 and mounting pin 305, as illustrated in FIG. 4, have been inserted into respective anchor bracket 107 such that the channel 205 in multi-cable clip 110 engages with a corresponding ridge (not shown) in anchor bracket 107, and the subassembly is translated (slid) until mounting flanges 210 engage with anchor bracket 107 and key handle 310 of mounting pin 305 passes through an aperture in anchor bracket 107 (given that key handle is in the proper orientation to fit through the aperture) and able to be rotated. Once in place, a technician may rotate key handle 310 to engage with the surface of anchor bracket 107, thereby preventing multi-cable clip 110 from translating within anchor bracket 107.

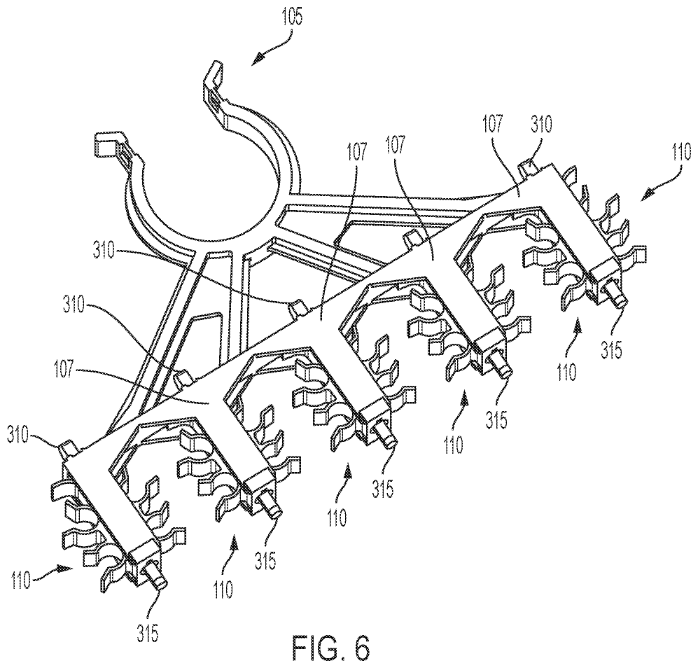

FIG. 6 repeats the illustration of FIG. 1 but highlighting details of the mounting of multi-cable clips 110. Shown in FIG. 6, for each multi-cable clip 110, are the rotated key handles 310 and engaged retaining features 315, each serving to fix the multi-cable clips 110 within respective anchor brackets 107 and thus within multi-clip frame 105.

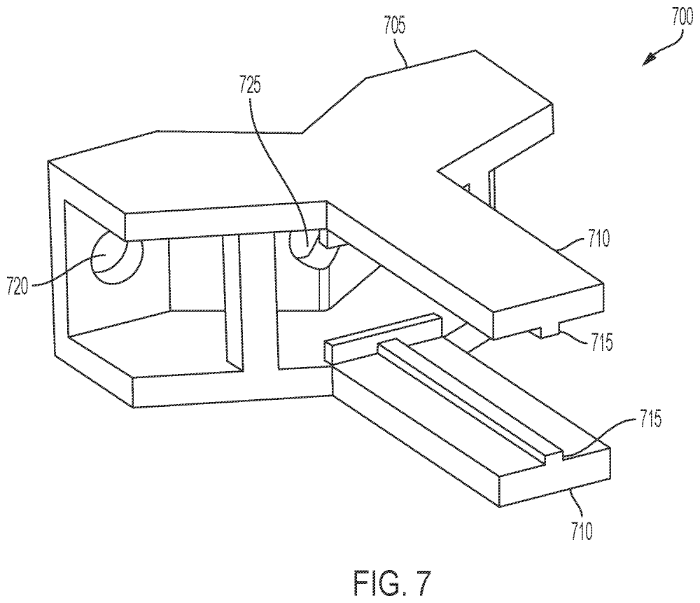

FIG. 7 illustrates an exemplary standalone anchor bracket 700 according to the disclosure. Standalone anchor bracket 700 may be used in place of multi-clip frame 105 for deployments, such as indoor deployments, in which a single multi-cable clip 110 may be mounted to a wall, ceiling. or other surface. Alternatively, standalone anchor bracket 700—or a plurality thereof—may be affixed to a variation of multi-clip frame 105 whereby multi-clip frame 105 would not have integrated anchor brackets 107. It will be understood that such variations are possible and within the scope of the disclosure.

Standalone anchor bracket 700 has a base 705 with two bracket arms 710, each of which having a ridge 715 configured to engage with channel 205 of multi-cable clip 110. Base 705 also has a plurality of screw holes 720 for mounting standalone anchor bracket 700 to a wall or ceiling; and an aperture 725 for inserting mounting pin 305.

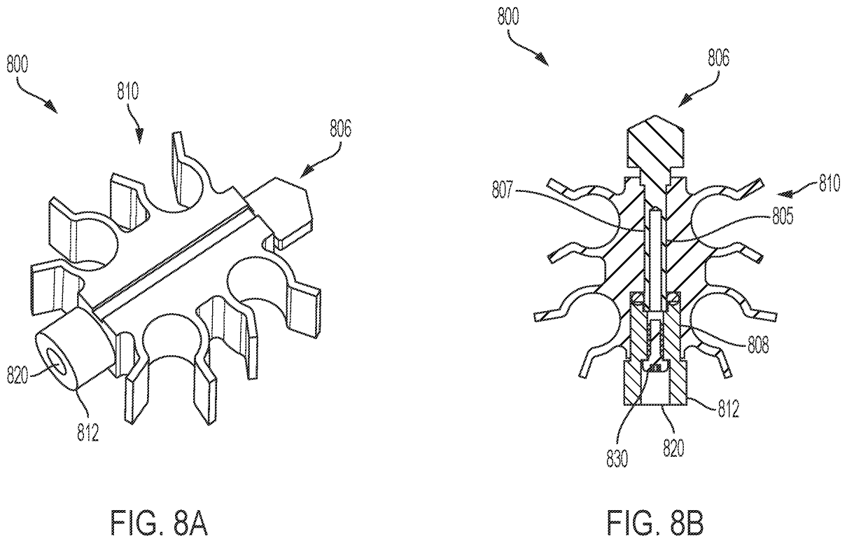

FIGS. 8A and 8B illustrate an exemplary subassembly 800 of a multi-cable clip 810 and an exemplary hand-turn mounting pin 805 of a second embodiment of the disclosure. Multi-cable clip 810 may be similar to multi-cable clip 110, except for its aperture 820 that has two different diameters to accommodate hand-turn mounting pin 805. Hand-turn mounting pin 805 has a first section 807 having a threaded aperture and a key handle 806; and a second section 808 that has a base end 812 with an aperture 820 configured to accept a screw 830. Mounting pin 805 is configured to rotate freely within aperture 802 of multi-cable clip 810.

An advantage of subassembly 800 is that mounting pin 805 may have a more robust mechanism for holding multi-cable clip 810 in anchor bracket 107 or standalone anchor bracket 700 that with mounting pin 305 having retaining feature 315. Subassembly 800 may be mounted within anchor bracket 107 or standalone anchor bracket 700 the same way as subassembly 400. Further, it would be possible for both subassemblies 400 and 800 to be mounted within the same multi-clip frame 105.

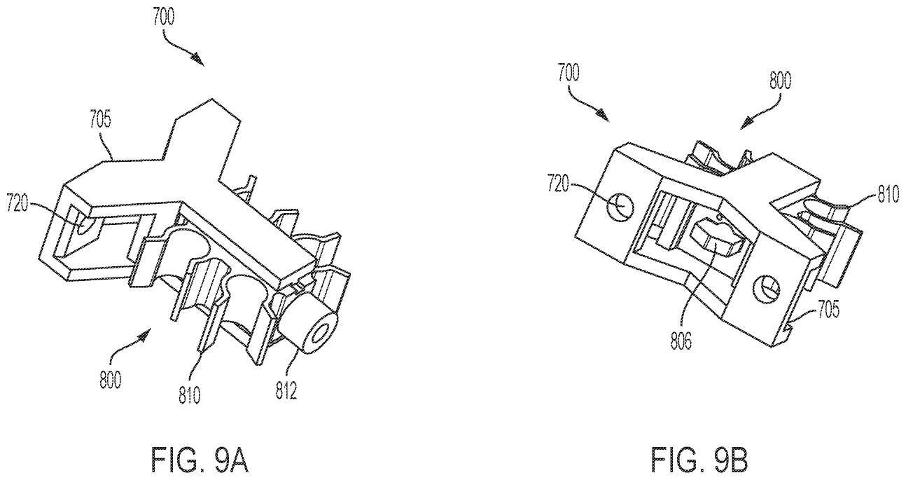

FIGS. 9A and 9B illustrate subassembly 800 installed in a standalone anchor bracket 700 according to the disclosure. Subassembly 800 may be installed into standalone anchor bracket 700 in a manner similar to that described above with anchor brackets 107.

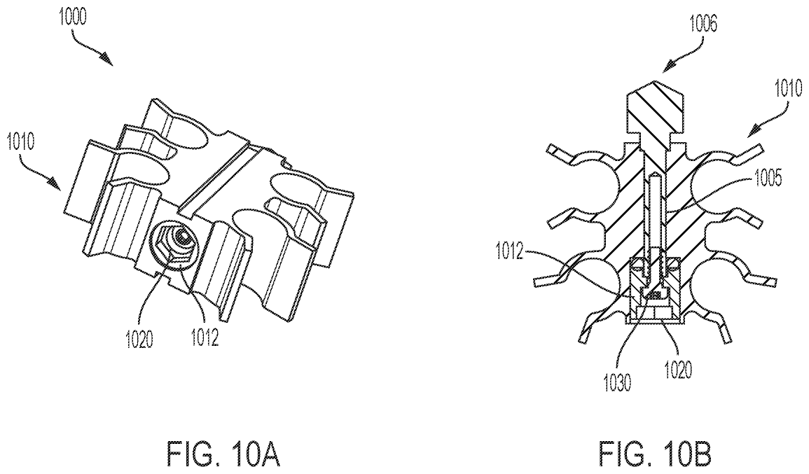

FIGS. 10A and 10B illustrate an exemplary subassembly 1000 of a multi-cable clip 1010 and mounting pin 1005 having a hex wrench mount. Multi-cable clip 1010 has an aperture that may be segmented with two different diameters in a manner similar to multi-cable clip 810 of subassembly 800. A difference between mounting pin 1005 and mounting pin 805 is that mounting pin 1005 has an aperture 1020 that is configured to engage with a hex wrench mount 1030.

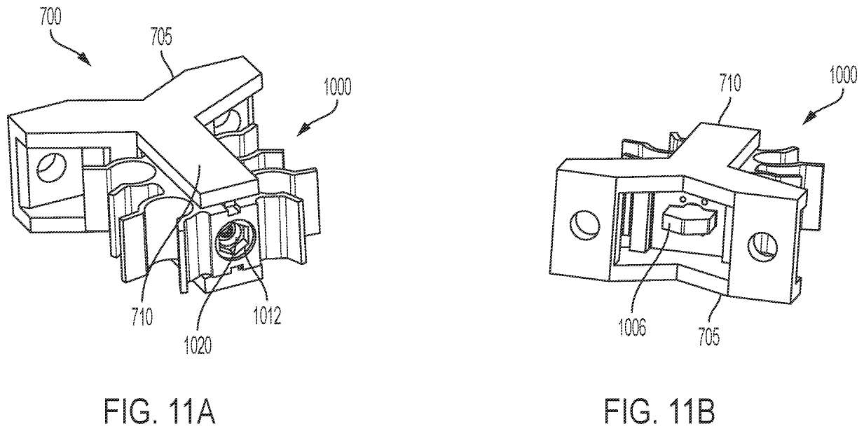

FIGS. 11A and 11B illustrate subassembly 1000 installed onto standalone anchor bracket 700. As with subassemblies 400 and 800, subassembly 1000 may be installed onto standalone anchor bracket 700 or one or more anchor brackets 107 of multi-clip frame 105.

An advantage of the disclosed cable management apparatus is that it requires very few tools (the first embodiment requires no tools, the second embodiment requires a screwdriver, and the third embodiment requires an Allen wrench), and parts that can be easily fitted together and installed in challenging environments, such as the top of a cell tower.

1. A cable management apparatus, comprising:
an anchor bracket; and
a multi-cable clip mounted to the anchor bracket, wherein the multi-cable clip has a plurality of tabs defining a plurality of slots, wherein each of the plurality of slots is configured to hold a cable.

2. The cable management apparatus of claim 1, further comprising a mounting pin, the mounting pin being configured to be inserted through a first aperture within the anchor bracket and a second aperture within the multi-cable clip.

3. The cable management apparatus of claim 2, wherein the mounting pin comprises:
a key handle disposed at a first end; and
a retaining feature disposed at a second end.

4. The cable management apparatus of claim 2, wherein the mounting pin comprises:
a first section having a key handle disposed at a first end; and
a second section having an aperture disposed at a second end, wherein the first section and the second section are configured to be mechanically coupled by a fastener.

5. The cable management apparatus of claim 4, wherein the fastener comprises a screw.

6. The cable management apparatus of claim 4, wherein the fastener comprises an Allen fastener.

7. The cable management apparatus of claim 2, wherein the multi-cable clip and the mounting pin are formed of the same material.

8. The cable management apparatus of claim 2, wherein the multi-cable clip is formed of a first material having a first thermal expansion coefficient and the mounting pin is formed of a second material having a second thermal expansion coefficient, wherein the first thermal expansion coefficient and the second thermal expansion coefficient are substantially equal.

9. A cable management apparatus, comprising:
a multi-clip frame having a plurality of anchor brackets; and
a plurality of multi-cable clips, wherein each of the multi-cable clips is mounted to a corresponding anchor bracket.

10. The cable management apparatus of claim 9, further comprising a mounting pin mechanically coupling a corresponding multi-cable clip to a corresponding anchor bracket, wherein the mounting pin is configured to be inserted through a first aperture within the corresponding anchor bracket and a second aperture within the corresponding multi-cable clip.

11. The cable management apparatus of claim 10, wherein the mounting pin comprises:
a key handle disposed at a first end; and
a retaining feature disposed at a second end.

12. The cable management apparatus of claim 10, wherein the mounting pin comprises:
a first section having a key handle disposed at a first end; and
a second section having an aperture disposed at a second end,
wherein the first section and the second section are configured to be mechanically coupled by a fastener.

13. The cable management apparatus of claim 12, wherein the fastener comprises a screw.

14. The cable management apparatus of claim 12, wherein the fastener comprises an Allen fastener.
